(19) United States
(12) Patent Application Publication
(10) Pub. No.: US 2003/0210420 A1
(43) Pub. Date: Nov. 13, 2003

(54) Print system, portable information device, print apparatus, print data source apparatus, print execution method, program, and storage medium

(75) Inventor: Mitsugu Yamauchi, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/424,708

(22) Filed: Apr. 29, 2003

(30) Foreign Application Priority Data
May 8, 2002 (JP) 2002-132637

(51) Int. Cl. G06F 15/00; B41J 1/00; B41B 1/00

(52) U.S. Cl. 358/1.14; 358/1.15

(57) ABSTRACT

A print system is provided which, even in a print apparatus not provided with a display input device with which a complicated operation can be performed by a user, makes it possible to execute printing with the print apparatus as the user himself/herself inputs a password from a portable information device in front of the print apparatus, and realizes security printing for realizing improvement of confidentiality and prevention of robbery of printed materials. The print system includes: a PC which sends a cellular phone number of a cellular phone, a password of security printing, and print data of a printed document to a printer; a printer which sends a program for password input operation to the cellular phone, collates the password received from the PC and the password received from the cellular phone and, in the case in which both the passwords coincide with each other, executes printing based upon print data; and a cellular phone which sends a password which is inputted based upon the program for password input operation sent from the printer to the printer.

### BACKGROUND OF THE INVENTION

1. Field of the Invention

The present invention relates to a print system, a portable information device, a print apparatus, a print data source apparatus, a print execution method, a program, and a storage medium which are preferable when applied to a printing system which makes it possible to print a confidential document or the like based upon a password inputted by communication via a wireless interface utilizing a portable information device.

2. Related Background Art

In recent years, printers have been shared by a plurality of users via a network. Such printers can be roughly divided into two types. A printer of a first type is a printer which is provided with a facsimile and a scanner section and is used as a multi function printer (MFP), and is further provided with a liquid crystal display input device, thereby allowing a user to apply various operation inputs to the MFP.

A printer of a second type is a printer which is not provided with input devices such as a liquid crystal display input device and a switch (hereinafter referred to simply as input devices) from the viewpoint of cost reduction and design.

In addition, in recent years, there is a security printing system in which a print job is held without being instantly printed by a printer and, when a user wishes to perform printing, the user inputs an ID and a password, thereby printing the held print job.

The printer provided with the liquid crystal display input device is suitable for the security printing system because a user ID and a password can be inputted by the liquid crystal input device in the printer.

On the other hand, in the printer not provided with the liquid crystal display input device, in order to cope with printing of a confidential document or the like, a user instructs a printer to execute printing from a personal computer (hereinafter abbreviated as PC), a password for the confidential document to be printed is issued by print software on the PC, and the user himself/herself inputs the issued password on a keyboard of the PC to send it to the printer. In this way, the printer copes with the security printing system.

However, in the security printing system in the printer not provided with the liquid crystal display input device, problems as described below are likely to occur. That is, since the printer itself is not provided with the liquid crystal display input device, the system is not suitable for the user himself/herself to input the password in front of the printer. In such a case, as described above, the password can be sent to the printer from the PC via the network. However, there is a disadvantage that, in the case in which the PC and the printer are set in places remote from each other, it is likely that a printed confidential document is seen by other users or stolen before the user goes to the front of the printer to take the printed confidential document after the password is sent from the PC to the printer.

### SUMMARY OF THE INVENTION

The present invention has been devised in view of the above-described problems, and it is an object of the present invention to provide a print system, a print apparatus, a print control method, and a print control program which make it possible to execute printing in a print apparatus as a user himself/herself inputs a password from a portable information device in front of the print apparatus, thereby making it possible to realize confidential document printing (security printing) capable of realizing improvement of confidentiality and prevention of robbery of printed materials.

In order to attain the above-described object, the present invention provides a print system which is capable of instructing printing through wireless communication, characterized by including: a print apparatus which sends a predetermined program through wireless communication; and a portable information device which makes it possible to input a password for using the print apparatus based upon the predetermined program sent from the print apparatus and sends the inputted password to the print apparatus through wireless communication.

In addition, the present invention provides a portable information device capable of wirelessly communicating with a print apparatus, characterized by including: a storage unit which stores a program for password input operation sent from the print apparatus; an input unit which makes it possible to input a password for using the print apparatus based upon the program for password input operation; and a wireless communication unit which performs reception of the program for password input operation sent from the print apparatus and transmission of the password to the print apparatus.

In addition, the present invention provides a print apparatus capable of wirelessly communicating with a print data source apparatus and a portable information device, characterized by including: a wireless communication unit which performs reception of identification information of the portable information device, a password, and print data from the print data source apparatus and transmission of a program for password input operation to the portable information device; a collation unit which collates the password sent from the print data source apparatus and the password sent from the portable information device having the identification information; and a print unit which, in the case in which both the passwords coincide with each other, executes printing based upon the print data received from the print data source apparatus.

Further, the present invention provides a print data source apparatus capable of wirelessly communicating with a print apparatus for executing printing based upon input of a password from a portable information device, characterized by including a wireless communication unit which sends identification information of the portable information device, the password, and print data to the print apparatus.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

In the accompanying drawings,

FIG. 1 is a block diagram showing a structure of a printing system in accordance with an embodiment of the present invention;

FIG. 2 is a flowchart showing a flow of operations of a PC constituting the printing system in accordance with the embodiment of the present invention;

FIG. 3 is a flowchart showing a flow of operations of a printer constituting the printing system in accordance with the embodiment of the present invention; and

FIG. 4 is a flowchart showing a flow of operations of a cellular phone constituting the printing system in accordance with the embodiment of the present invention.

### DETAILED DESCRIPTION OF THE PREFERRED EMBODIMENTS

Embodiments of the present invention will be described in detail with reference to the accompanying drawings.

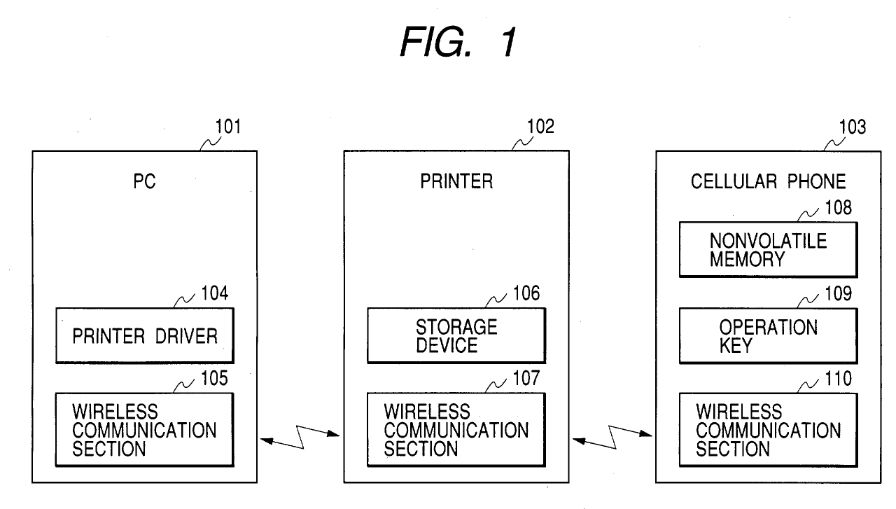

FIG. 1 is a block diagram showing a structure of a printing system in accordance with an embodiment of the present invention. This printing system includes: a personal computer (hereinafter abbreviated as PC) 101 provided with printer driver software (hereinafter abbreviated as printer driver) 104 and a wireless communication section 105; a printer 102 provided with a storage device 106 and a wireless communication section 107; and a cellular phone 103 provided with a nonvolatile memory 108, an operation key 109, and a wireless communication section 110. Note that illustration of other components in the PC 101, the printer 102, and the cellular phone 103 will be omitted. In addition, it is assumed that the operation key 109 is an input device for operating scroll of a print setting menu and determination of print setting and is an operation key with a simple structure which is not suitable for input of a user ID and a password and becomes a problem in the present invention.

The above-described structure will be described in detail. The PC 101 performs instruction for start of printing of a confidential document or the like (hereinafter referred to as security printing), display of a password based upon a cellular phone number of the cellular phone 103 inputted on the PC 101, transmission of print data, the cellular phone number, and the password to the printer 102, and the like in the printing system. The PC 101 includes a storage section for storing various data, a display section for displaying various screens, an operation section for a keyboard, a mouse, and the like, and a control section for controlling each section of the PC (these are not illustrated) other than the printer driver 104 and the wireless communication section 105. In the PC 101, the printer driver 104 is software for sending a document prepared by the PC 101 to the printer 102 as print data. The wireless communication section 105 is capable of sending and receiving various data to and from an external device (the printer 102 in the case of this embodiment).

The printer 102 includes a data reception function for receiving print data, a cellular phone number, and a password sent from the PC 101, an operation program transmission function for sending a program for password input operation to the cellular phone 103, a password input confirmation function for performing reception and confirmation of a password sent from the cellular phone 103, and a print function for performing printing on a predetermined sheet based upon print data sent from the PC 101. Further, the printer 102 includes, as a physical structure, an image forming section (printing unit) for performing printing on a sheet and a control section (collating unit) for controlling each part of the printer (these sections are not illustrated) other than the storage device 106 and the wireless communication section 107. Note that, in this embodiment, the printer 102 itself is not provided with an input device such as a liquid crystal display input device or a switch suitable for inputting a user ID and a password. In the printer 102, the storage device 106 is constituted by a memory such as a RAM to be a work area and a temporary storage area, and an HD (hard disk) having stored therein a control program, a program for password input operation, and the like. In this embodiment, the storage device 106 will be described assuming that it is an HD. The wireless communication section 107 is capable of sending and receiving various data to and from external devices (the PC 101 and the cellular phone 103 in the case of this embodiment).

The cellular phone 103 includes a storage function for storing a program for password input operation sent from the printer 102 and a communication function for sending a password to the printer 102 by operating the inputted program for password input operation. Further, the cellular phone 103 includes, as a physical structure, a display section for displaying various screens and a control section for controlling each part of the cellular phone (these are not illustrated) other than the nonvolatile memory 108, the operation key 109, and the wireless communication section 110. Note that, although the case in which a portable information device is assumed to be the cellular phone 103 is described in this embodiment, it may be other portable information devices. In the cellular phone 103, the nonvolatile memory 108 is constituted by, for example, a flash memory and stores a cellular phone operation program and various data for preservation. The operation key 109 is for operating the cellular phone 103 and includes a ten key, a transmission key, and a reception key. The wireless communication section 110 is capable of not only communicating with other cellular phones but also sending and receiving various data to and from other devices (the printer 102 in the case of this embodiment).

Next, operations of the PC 101, the printer 102, and the cellular phone 103, which constitute the printing system in accordance with this embodiment as described above, will be described in detail with reference to FIGS. 1 to 4.

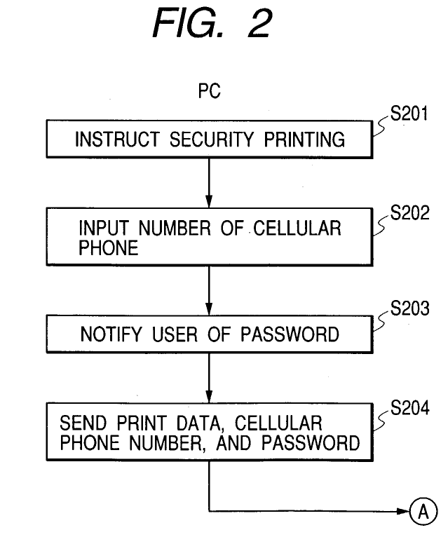

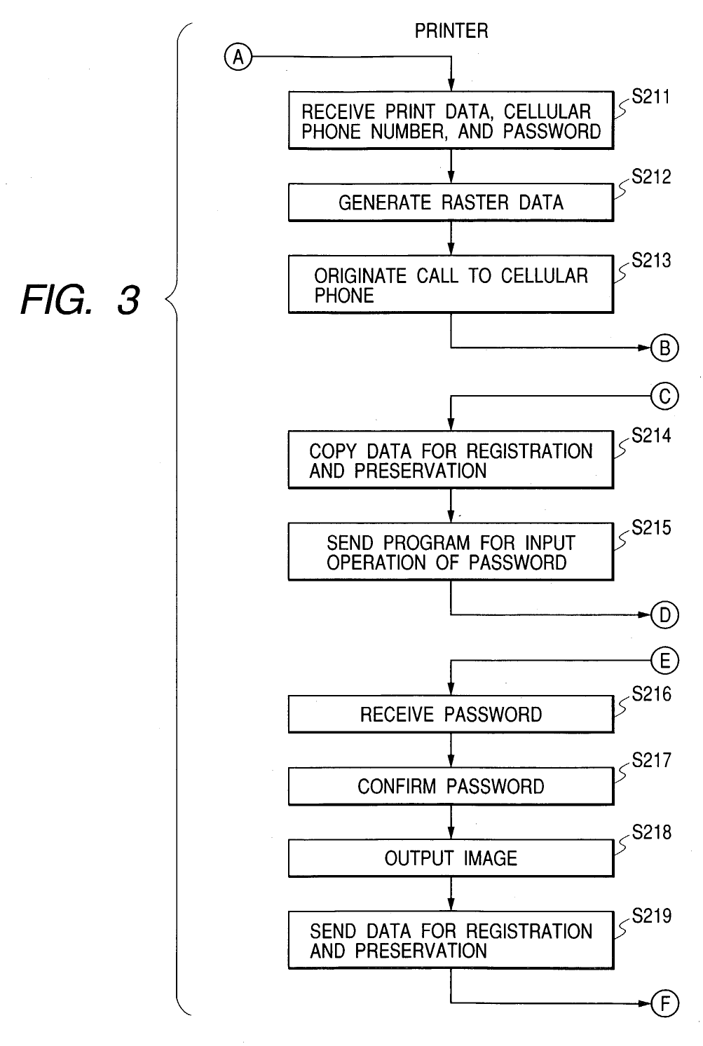

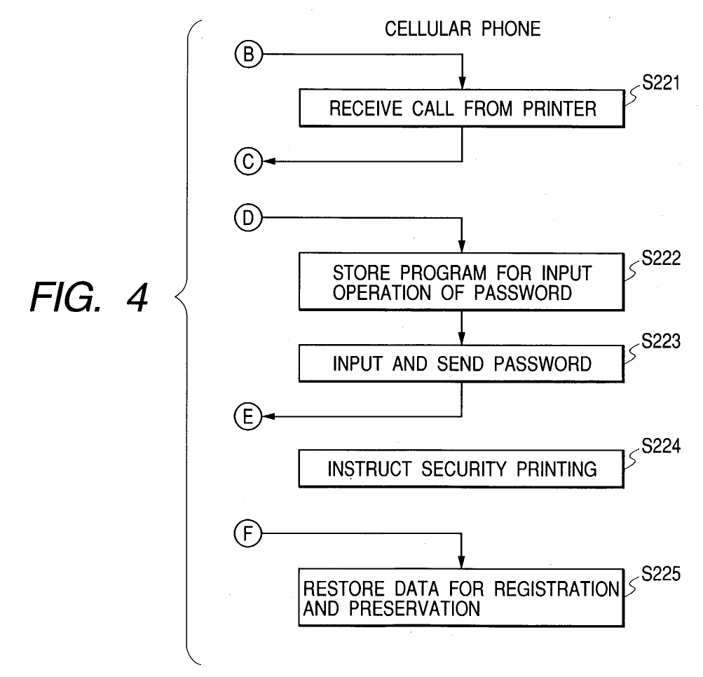

FIG. 2 is a flowchart showing a flow of operations of the PC 101. FIG. 3 is a flowchart showing a flow of operations of the printer 102. FIG. 4 is a flowchart showing a flow of operations of the cellular phone 103. Steps S201 to S204 of FIG. 2 represent a process of the operations of the PC 101, and the operations of the PC 101 are performed by the printer driver 104 on the PC 101. Steps S211 to S219 of FIG. 3 represent a process of the operations of the printer 102. Steps S221 to S225 of FIG. 4 represent a process of the operations of the cellular phone 103.

A user instructs start of printing (security printing) of a confidential document or the like on a screen of the display section in the PC 101 of this printing system. In response to the instruction, in step S201 of FIG. 2, the PC 101 inputs a print instruction with respect to the confidential document to be printed. Then, the printer driver 104 on the PC 101 displays a screen for urging the user to input a cellular phone number of the cellular phone 103 on the display section. The user operates a keyboard (not shown) while looking at the screen of the display section of the PC 101, whereby, in step S202, the PC 101 inputs the cellular phone number of the cellular phone 103 owned by the user. In this embodiment, since the cellular phone 103 is used as a portable information device, the cellular phone number of the cellular phone 103 is used as a number which can specify the portable information device. However, in the case in which another portable information device is used, a number or an address which can specify the device is used properly.

When the cellular phone number of the cellular phone 103 is inputted by the user, in step S203, the printer driver 104 of the PC 101 displays a number of a few digits using a random number list or the like on the screen of the PC 101, thereby notifying the user of the number of a few digits. The number of a few digits is a password which is required when a document, which the user intends to print through the security printing, is actually printed to be outputted from the printer 102. In this embodiment, the password is assumed to be the number of a few digits which is given by a random number list. However, it may be a number which the user can determine arbitrarily or may be an alphabet or another symbol. Next, in step S204, the printer driver 104 of the PC 101 generates print data based upon the confidential document to be printed and sends the print data of the print document to the printer 102 through the wireless communication section 105 together with the cellular phone number of the user and the password for the security printing.

In step S211 of FIG. 3, the printer 102 receives the cellular phone number of the user, the password, and the print data sent from the PC 101 through the wireless communication section 107. Then, in step S212, the printer 102 generates raster data of the print document based upon the print data received from the PC 101 with the control section. Next, when the raster data is generated for one page or a few pages, in step S213, the printer 102 originates a call to the cellular phone number of the user, which is received from the PC 101, through the wireless communication section 107. The user holding the cellular phone 103 goes to the front of the printer 102, and in step S221 of FIG. 4, when the operation key 109 of the cellular phone 103 is operated by the user, the cellular phone 103 receives the call from the printer 102 through the wireless communication section 110.

When the call from the printer 102 is received in the cellular phone 103, in step S214, the printer 102 reads data on the nonvolatile memory 108 in the cellular phone 103 with the control section and copies the data to the storage device 106 in the printer 102. The data to be copied to the storage device 106 in the printer 102 from the nonvolatile memory 108 in the cellular phone 103 is usually various data for registration and preservation of the cellular phone 103, for example, data of a telephone number list. When the copying of the data for saving registrations to the storage device 106 ends, next, in step S215, the printer 102 sends the program for password input operation stored in the storage device 106 to the cellular phone 103 through the wireless communication section 107. Consequently, the program for password input operation is written in an area in the cellular phone 103 where the various data for registration and preservation was stored.

In step S222, the cellular phone 103 receives the program for password input operation from the printer 102 via the wireless communication section 110 according to the operation of the printer 102 and stores the program for password input operation in the nonvolatile memory 108 in the cellular phone 103. Since the program for password input operation from the printer 102 is stored in the nonvolatile memory 108 in the cellular phone 103, the program for password input operation is executed on the cellular phone 103, and the cellular phone 103 operates according to the program for password input operation. More specifically, in step S223, the cellular phone 103 executes the program for password input operation, thereby causing the display section of the cellular phone 103 to display a password input screen, and sends the password which the user inputted with the operation key 109 to the printer 102. The user inputs the notified password, which is a number of a few digits, with the operation key 109 of the cellular phone 103, and sends the password to the printer 102 through the wireless communication section 110. Thereafter, in step S224, the cellular phone 103 instructs the printer 102 to perform security printing via the wireless communication section 110 according to an instruction from the user.

In step S216, the printer 102 receives the password sent from the cellular phone 103 through the wireless communication section 107. Then, in step S217, the printer 102 confirms whether or not the password sent from the cellular phone 103 coincides with the password received together with the print data from the PC 101 (collates both the passwords) with the control section of the printer 102. Next, after confirming that both the passwords coincide with each other with the control section, in step S218, the printer 102 outputs the raster data which has already been generated in the process of step S212 to the image forming section and performs image output to a predetermined sheet through the image forming section.

Then, in step S219, after completing the image output, the printer 102 sends the various data for registration and preservation, which were copied to the storage device 106 in the process of step S214, to the cellular phone 103 through the wireless communication section 107. Consequently, in step S225, the cellular phone 103 writes the various data for registration and preservation in the area in the nonvolatile memory 108 of the cellular phone 103 where the data was stored. Since the various data for registration and preservation has been restored, the cellular phone 103 becomes capable of operating as a usual cellular phone.

As described above, according to this embodiment, the print data of the print document is sent to the printer 102 by the printer driver 104 on the PC 101 together with the cellular phone number of the user and the password for the security printing, and the printer 102 copies the various data for registration and preservation of the cellular phone 103 to the storage device 106 and sends the program for password input operation to the cellular phone 103 instead of the various data for registration and preservation sent from the cellular phone 103. Consequently, it becomes possible to operate the cellular phone 103 according to the program for password input operation. In addition, the user inputs the password using the operation key 109 of the cellular phone 103, whereby it becomes possible to realize security printing by the printer 102.

Therefore, in this embodiment, even in the case in which the PC 101 and the printer 102 are set in places remote from each other, since printing on a predetermined sheet is not executed until the user goes to the front of the printer 102 and inputs the password from the cellular phone 103 after execution of security printing is instructed by the PC 101, an effect is realized in that it is not likely that a printed confidential document is seen by other users or the printed confidential document is stolen.

In this embodiment, the case in which the portable information device is the cellular phone is described as an example. However, the present invention is not limited to this and, for example, a portable information device such as a personal digital assistant (PDA) can be used.

In this embodiment, a print system of a printer is not limited to a specific print system, and various print systems such as an electrophotographic system, an ink jet system, a thermal transfer system, and a thermal system can be used.

In addition, the present invention may be applied to a system constituted by a plurality of devices or may be applied to an apparatus constituted by one device. It is needless to mention that the present invention is also attained by supplying a medium such as a storage medium, which has stored therein a program code of software for realizing the function of the above-described embodiment, to a system or an apparatus, and a computer (or a CPU or an MPU) of the system or the apparatus reading out to execute the program stored in the medium such as the storage medium.

In this case, the program code itself read out from the medium such as the storage medium realizes the function of the above-described embodiment, and the medium such as the storage medium having stored therein the program code constitutes the present invention. As the medium such as the storage medium for supplying the program code, for example, a floppy (registered trademark) disk, a hard disk, an optical disk, a magneto-optical disk, a CD-ROM, a CD-R, a magnetic tape, a nonvolatile memory card, a ROM, or download via a network can be used.

In addition, it is needless to mention that the present invention includes not only the case in which the function of the above-described embodiment is realized by the computer executing the read-out program code but also the case in which an OS or the like running on the computer performs a part or all of actual processing based upon an instruction of the program code, and the function of the above-described embodiment is realized by the processing.

Moreover, it is needless to mention that the present invention also includes the case in which, after the program code read out from the medium such as the storage medium is written in a memory provided in a function extended board inserted in the computer or a function extended unit connected to the computer, a CPU or the like provided in the function extended board or the function extended unit performs a part or all of actual processing based upon an instruction of the program code, and the function of the above-described embodiment is realized by the processing.

As many apparently widely different embodiments of the present invention can be made without departing from the spirit and scope thereof, it is to be understood that the invention is not limited to the specific embodiments thereof except as defined in the appended claims.

As described above, according to the present invention, since a program for password input operation is sent to a portable information device from a print apparatus, a password inputted in the portable information device based upon execution of the program for password input operation is sent to the print apparatus, and printing is executed based upon collation of the passwords in the print apparatus, even in a print apparatus not provided with an input device, a user himself/herself inputs the password from the portable information device in front of the print apparatus, whereby it becomes possible to execute printing in the print apparatus and to realize confidential document printing (security printing) capable of realizing improvement of confidentiality and prevention of robbery of printed materials.

What is claimed is:

1. A print system in which a print control apparatus and a portable information device are capable of communicating with each other,
wherein said print control apparatus comprises:
inputting means which inputs specific information specifying said portable information device;
program transmission means which communicates with said portable information device to be specified by the specific information inputted from said inputting means and transmits a program for operation for instructing printing of a print document to said portable communication device;
reception means which communicates with said portable information device and receives a print instruction sent by the program for operation operating in said portable information device; and
print execution means which executes print processing of the print document after the print instruction is received from said portable information device by said reception means, and
said portable information device comprises:
program reception means which communicates with said print control apparatus and receives the program for operation for instructing printing of the print document from said print control apparatus; and
print instruction transmission means which executes the received program for operation and sends a print instruction based upon an operation input from a user to said print control apparatus.

2. A print control apparatus which is capable of communicating with a portable information device, comprising:
inputting means which inputs specific information for specifying said portable information device;
program transmission means which communicates with a portable information device to be specified by the specific information inputted from said inputting means and transmits a program for operation for instructing printing of a print document to said portable communication device;
reception means which communicates with said portable information device and receives a print instruction sent by the program for operation operating in said portable information device; and
print execution means which executes print processing of the print document after the print instruction is received from said portable information device by said reception means.

3. The print control apparatus according to claim 2,
wherein said portable information device is a cellular phone, and
said specific information is a telephone number of the cellular phone.

4. The print control apparatus according to claim 2,
wherein said program for operation is a program for allowing input of a password for instructing printing with respect to the print document, and
said reception means receives a password for instructing printing with respect to the print document from said portable information device.

5. The print control apparatus according to claim 2,
wherein said inputting means inputs specific information specifying said portable information device from a client apparatus which is a transmission destination of the print document.

6. The print control apparatus according to claim 5,
wherein said inputting means further inputs a password for instructing printing with respect to the print document from said client apparatus and stores the password in storage means.

7. The print control apparatus according to claim 6, further comprising judging means which judges whether or not the password stored in said storage means and a password received from said reception means coincide with each other,
wherein, in the case in which it is judged by said judging means that the two passwords coincide with each other, said print execution means executes print processing of the print document.

8. The print control apparatus according to claim 2, further comprising wireless communication means which performs wireless communication with said portable information device.

9. A print method carried out in a print system in which a print control apparatus and a portable information device are capable of communicating with each other, comprising the steps of:
inputting specific information specifying the portable information device in the print control apparatus;
communicating with the portable information device to be specified by the specific information inputted and transmitting a program for operation for instructing printing of a print document to the portable communication device in the print control apparatus;
communicating with the portable information device and receiving a print instruction sent by the program for operation operating in the portable information device in the print control apparatus;
executing print processing of the print document after the print instruction is received from the portable information device in the print control apparatus;
communicating with the print control apparatus and receiving the program for operation for instructing printing of the print document from the print control apparatus in the portable information device; and
executing the received program for operation and sending a print instruction based upon an operation input from a user to the print control apparatus in the portable information device.

10. A method carried out in a print control apparatus which is capable of communicating with a portable information device, comprising the steps of:
inputting specific information for specifying the portable information device;
communicating with a portable information device to be specified by the specific information inputted and transmitting a program for operation for instructing printing of a print document to the portable communication device;
communicating with the portable information device and receiving a print instruction sent by the program for operation operating in the portable information device; and
executing print processing of the print document after the print instruction is received from the portable information device.

11. The method according to claim 10, wherein the portable information device is a cellular phone, and the specific information is a telephone number of the cellular phone.

12. The method according to claim 10, wherein the program for operation is a program for allowing input of a password for instructing printing with respect to the print document, and said receiving step further comprises the step of receiving a password for instructing printing with respect to the print document from the portable information device.

13. The method according to claim 10, wherein said inputting step further comprises the step of inputting specific information specifying the portable information device from a client apparatus which is a transmission destination of the print document.

14. The method according to claim 13, wherein said inputting step further comprises the step of inputting a password for instructing printing with respect to the print document from the client apparatus and storing the password in storage means.

15. The method according to claim 14, further comprising the step of judging whether the password stored in the storage means and a password received in said reception step coincide with each other, wherein said print execution step further comprises the step of executing print processing of the print document in the case in which it is judged that the two passwords coincide with each other.

16. The method according to claim 10, further comprising the step of performing wireless communication with the portable information device.
